(19) United States
(12) Patent Application Publication
(10) Pub. No.: US 2017/0252944 A1
(43) Pub. Date: Sep. 7, 2017

(54) Surface Coatings

(71) Applicant: RAMPF FORMEN GMBH, Allmendingen (DE)

(72) Inventors: Peter Dauben, Bad Sassendorf (DE); Andreas Woerz, Blaustein (DE)

(21) Appl. No.: 15/506,685

(22) PCT Filed: Aug. 26, 2015
(86) PCT No.: PCT/EP2015/001741

§ 371 Date: Feb. 24, 2017

(30) Foreign Application Priority Data
Aug. 27, 2014 (DE) 10 2014 012 738.9

(51) Int. Cl. B28B 7/36; B28B 3/06; B28B 7/38; B28B 3/02; B28B 7/00; B28B 7/24

(52) U.S. Cl. CPC B28B 7/36; B28B 7/0002; B28B 7/0097; B28B 7/24; B28B 7/38; B28B 3/022; B28B 3/06

(57) ABSTRACT

The present invention relates to a mold and a pressure piece for producing molded bricks, in particular molded concrete bricks, a process for producing this mold or this pressure piece, an apparatus for producing molded bricks, a vibratable base for producing molded bricks, a metal drawing sheet for producing molded bricks, and also the use of a coating comprising an antiwear matrix and an antiadhesion component for surfaces of molds and/or pressure pieces and/or vibratable bases and/or metal drawing sheets used for producing molded bricks.

The present invention relates to a mold and a pressure piece for producing molded bricks, in particular molded concrete bricks, a process for producing this mold or this pressure piece, an apparatus for producing molded bricks, a vibratable base for producing molded bricks, a metal drawing sheet for producing molded bricks, and also the use of a coating comprising an antiwear matrix and an antiadhesion component for surfaces of molds and/or pressure pieces and/or vibratable bases and/or metal drawing sheets used for producing molded bricks.

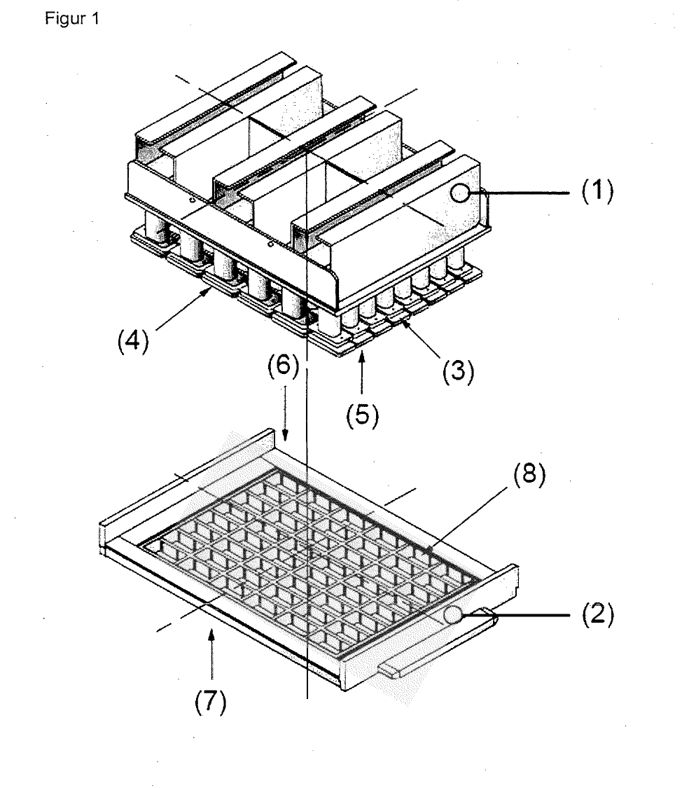

Molded bricks, in particular molded concrete bricks, are usually produced in apparatuses which comprise a mold with one or more mold nests. The mold nests usually have an open upper side, an open underside and mold nest walls between this upper side and underside. In the process for producing the molded bricks, this mold is placed on a vibratable base so that the undersides of the mold nests are closed. After filling of the mold nests with a moist concrete mix through the open upper sides, the upper sides of the mold nests are closed by means of pressure pieces, so that these press onto the concrete mix (see FIG. 1). The vibratable base then provides for the mold to be vibrated, in particular in the vertical direction, with the vibrations of the base propagating into the concrete mix which as a result densifies in a short time to form dimensionally stable molded concrete bricks. In some cases, vibrating devices can also be installed on the mold itself.

Due to the particles of the concrete mix, the surfaces of the apparatus which come into contact with the concrete mix during the production process are subjected to considerable stress which leads to wear of the molds and/or pressure pieces and/or metal drawing sheets concerned.

To counter this wear, molds and pressure pieces provided with various coatings composed of, for example, chromium or manganese-alloyed metal sheets, which increase the wear resistance, have hitherto frequently been used. However, such molds and pressure pieces known from the prior art have various disadvantages: when chromium-plated molds and pressure pieces are used, pure chromium layers tend to undergo flaking, since after filling of the mold nests the pressure pieces are not always centered precisely in the mold and knocking of the components against one another can thus occur. The installation of further components such as manganese-alloyed metal sheets, on the other hand, has not been found to be economical and merely had the objective of increasing the operating life.

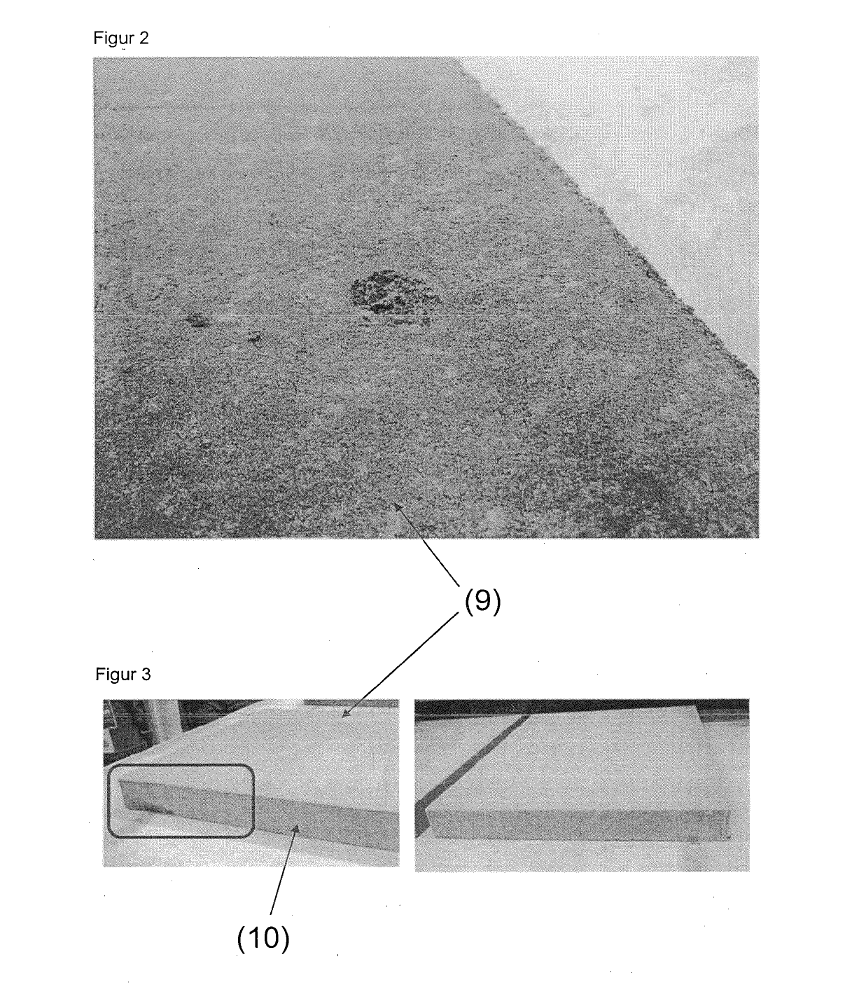

Concrete adhesions on the pressure piece or on the lower part of the mold, for example in the region of the spacers (brick lifters) lead to further problems in the molds known in the prior art. Spacers are generally milled indentations in the mold nest wall within the mold nests. These milled indentations (depressions) produce raised regions on the side face of the molded brick produced, which raised regions are necessary for packaging, laying and to prevent displacement in the laid state. If concrete builds up in the region of the spacers or of the pressure piece, this material is then missing on the molded brick produced and leads to defects on the molded brick surface (see FIG. 2). These defects lead to quality and functional deficiencies since the desired properties of the molded brick are no longer given. Thus, for example, the packability of the molded bricks after production, handling of the molded brick on the way to and on the building site and the securing of the bricks against displacement of the laid products are impaired. In order to prevent this, the molds have to be cleaned at intervals during production, which is associated with interruption of production. However, these production interruptions lead in turn to concrete material present in the stock hopper being able to cure to such an extent that the subsequently produced bricks can be too dry and thus have reduced stability and homogeneity. The brick manufacturing plants then frequently have to be completely emptied in the event of unplanned process interruptions and the concrete mix has to be disposed of.

To avoid these adhesions of concrete, molds and pressure pieces having coatings composed of Teflon or other polymers, in particular polyurethane or polyamide, have been proposed in the past. Teflon coatings display excessively high abrasion since no support structure is present, so that molds and pressure pieces have to be replaced after only a short time. Polyurethane coatings, in contrast, are springy and therefore absorb part of the densification energy, as a result of which the molded bricks produced have a poorer brick strength. In addition, polyurethane coatings are sensitive to scoring and polyamide coatings tend to undergo severe wear.

The use of heated molds and pressure pieces has also been proposed. Heating devices are necessary particularly when the concrete is processed in a moister state, i.e. with a higher W/C value (water/cement content). The higher moisture content results in the brick being able to be compacted better, makes the surface of the brick more closed and makes the brick able to slide off better on the upper side, i.e. be able to be smooth. However, moister concrete adheres more strongly to the components, in particular the mold walls or pressure pieces. Although heating of the mold nests and pressure pieces brings about a slight improvement in the adhesion of concrete, this leads to higher capital costs for the required regulation of the power and for the corresponding heating elements, and also to higher maintenance and operating costs resulting from the additional energy requirement. The reject rate also increases significantly due to the vibration sensitivity of the respective components (hotplates, cable connections, clamps, plugs, etc.). In addition, longer running-in times until the correct process temperatures are obtained and longer machine downtimes for heating of the components are necessary. A further disadvantage is that, in the production of the pressure pieces, the temperatures at which these are then to be operated in molded brick production has to be known precisely, since the pressure pieces are subject to thermal expansion when the temperature increases. However, the process temperatures are greatly dependent on the concrete aggregates used, so that it is not possible to produce different products, which accordingly require different process temperatures, by means of one and the same mold. In addition, the use of electrically operated heating elements results in unforeseeable liability risks for the manufacturer due to possible dangers to persons caused by defective electricity-conducting parts.

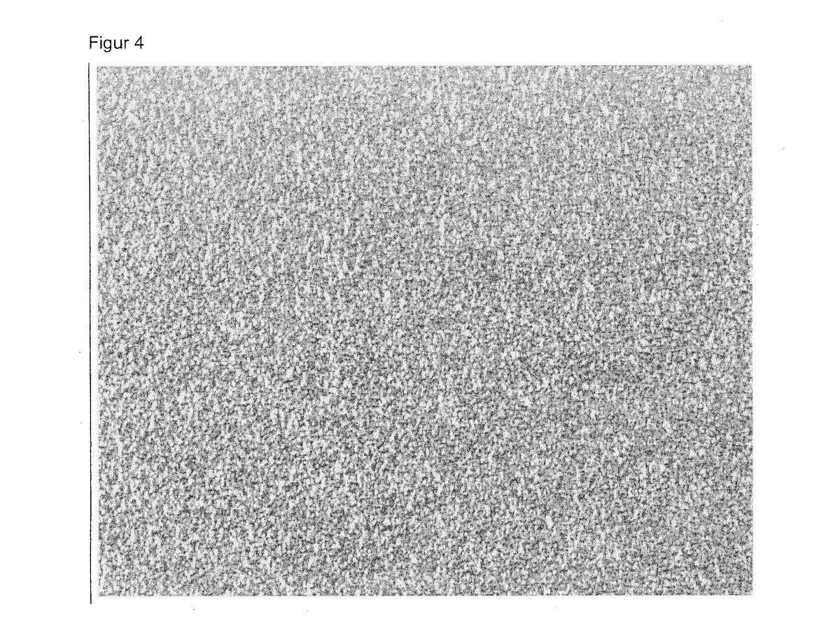

Owing to the friction between the components (pressure piece and mold wall or lower part of the mold and metal drawing sheet or vibratable base) and/or the friction between components and the concrete mix, there is additionally minimal metal abrasion of the components on each production contact. This abraded material deposits on the upper and side faces of the molded bricks. In the case of light-colored concrete bricks in particular, the abraded material itself and also the subsequent physicochemical reaction products lead to undesirable discoloration of the light-colored brick surfaces (see FIG. 3, left-hand image).

It is therefore an object of the present invention to overcome the above problems in the prior art and provide a mold, a pressure piece, a vibratable base and a metal drawing sheet for producing molded bricks, which have increased wear protection and improved antiadhesion properties relative to concrete and are thus easy and quick to clean and lead to low discoloration of the molded brick.

This object is achieved by the embodiments of the present invention characterized in the claims.

In particular, the invention provides a mold for producing molded bricks, wherein
the mold has one or more mold nests which can be filled with molded brick composition and have an open upper side and an open underside;
the mold nests have mold nest walls between the upper side and the underside; and
the mold nest walls have a coating at least in sections on the surfaces which come into contact with a pressure piece and/or with the molded brick composition during filling, where the coating comprises an antiwear matrix and an antiadhesion component and
the antiwear matrix is selected from among nickel-phosphorus alloy, sol-gel ceramic, silicon carbide (SiC), nanocrystalline hard materials, titanium nitrite, silicon nitride, tungsten carbides, DLC, zinc oxides, TiAlCN, AlCrN, AlTiCrN and/or ZrCrN.

The mold of the invention has one or more mold nests which can be filled with molded brick composition, in particular with concrete mix. In general, the molded brick composition can comprise fillers and binders which have physicochemical properties similar to those of moist concrete (e.g. ceramic, expanded clay, sintered materials, etc.). The mold nests each have an open upper side and underside and mold nest walls between the upper side and underside. The mold nest walls can either be continuous or have openings via which one brick is joined to the other via a concrete base. The present invention also relates to molds which have three-dimensionally structured mold nest walls which also make it possible to form a particular structure on the brick side walls, with the three-dimensionally structured mold nest walls then often being movable to take out the bricks. In this way, it is possible to replicate, for example, natural stone with a high-quality appearance.

The raw mold, i.e. the mold without coating, preferably consists of materials having a high density and sufficient strength for the vibrational energy to be introduced undamped into the concrete bricks. Such materials are, for example, building steels and wear steels in general, as are known to those skilled in the art. The geometric shape and size of the mold nests are, according to the invention, not subject to any particular restriction and can be chosen freely as a function of the molded brick to be produced. The wall thicknesses usually vary in the range from 5 to 50 mm.

According to the invention, the mold nest walls which come into contact with a pressure piece and/or with the molded brick composition during filling have, at least in sections, a coating on the surfaces, where the coating comprises an antiwear matrix and an antiadhesion component. In one embodiment, the surfaces which come into contact with a pressure piece and/or with the molded brick composition during filling are completely covered with the coating according to the invention. In another embodiment, only subregions of the surfaces are coated. Thus, for example, a partial coating can be present in the lower region of the mold to avoid wear and adhesion, which in this region produce the “elephant's feet” on the molded brick. Partial coatings in the region of the milled indentations in the mold nest wall (brick lifters) produce a reduction in the buildup of concrete within the mold nest wall.

According to the invention, the coating comprises an antiwear matrix and an antiadhesion component, with a combination of a plurality of antiwear matrices and a plurality of antiadhesion components also being possible. The antiwear matrix preferably forms a support structure in the coating according to the invention, in which the antiadhesion component is embedded. Such a coating advantageously combines a high wear resistance with excellent release properties, so that the mold of the invention displays both higher durability and improved antiadhesion properties in respect of concrete. In particular, the support structure (antiwear matrix) also wears during the gradual wearing away of the antiadhesion component, so that the removal of the support structure can result in exposure of further antiadhesion component particles which then continue to ensure excellent release properties. This advantageously results in an increased useful life of the mold of the invention, since the two wear rates of the support structure and the antiadhesion component are matched to one another. In addition, the coating according to the invention is inert under the usual production conditions, so that there is advantageously no reaction of abraded material with the molded brick and thus undesirable discoloration of the molded brick surface.

According to the invention, the antiwear matrix and antiadhesion component are not subject to any particular restrictions as long as they can be combined with one another in order to give the above advantageous effects. Here, the antiwear matrix can, for example, be in the form of a framework which accommodates the antiadhesion component, or, for example, also be present as particle dispersion within an antiadhesion component layer.

In a further embodiment of the present invention, the antiwear matrix and the antiadhesion component are formed by one (single) material in the coating which provides both properties. In a further embodiment, the antiwear matrix and the antiadhesion component are selected from among different materials, for example materials having different hardnesses. According to the present invention, the antiwear matrix can, for example, be selected from among metal alloys and the antiadhesion component can be selected from among a polymer or a mixture of polymers.

The antiwear matrix is, according to the invention, selected from among nickel-phosphorus alloy, sol-gel ceramic, silicon carbide (SiC), nanocrystalline hard materials, titanium nitrite, silicon nitride, tungsten carbides, DLC, zinc oxides, TiAlCN, AlCrN, AlTiCrN and/or ZrCrN, and can also contain combinations thereof.

In a preferred embodiment, the antiwear matrix is selected from among nickel-phosphorus alloy, sol-gel ceramic, silicon carbide (SiC) and nanocrystalline hard materials. In a particularly preferred embodiment, the antiwear matrix is a nickel-phosphorus alloy. Such a nickel-phosphorus alloy is particularly advantageously able to form both the antiwear matrix and the antiadhesion component simultaneously when only one coating material is used. In this embodiment, the nickel-phosphorus alloy can therefore be antiwear matrix and antiadhesion component at the same time. An analogous situation applies in the case of the above-mentioned antiwear materials if they also introduce an antiadhesion effect in the coating.

According to the present invention, a combination of a nickel-phosphorus alloy with a further antiwear matrix and/or a further antiadhesion component can provide a further-improved antiwear and antiadhesion effect.

According to the present invention, the term “nickel-phosphorus alloy” is not subject to any particular restriction and encompasses all alloys composed of the elements nickel and phosphorus, optionally with further elements as secondary alloying components. The nickel-phosphorus alloy advantageously forms a wear-bearing support structure in the coating. In a preferred embodiment, the nickel-phosphorus alloy has a phosphorus content of from 3 to 14% by weight, based on the total weight of the coating, preferably from 5 to 12% by weight, even more preferably from 7.5 to 9% by weight. The nickel-phosphorus alloy preferably has secondary alloying components in an amount of 5% by weight or less, based on the total weight of the coating. As secondary alloying component and/or intermediate layer, it is possible to use, for example, chromium, manganese, titanium, vanadium, tungsten, silicon, niobium, tantalum, boron and/or molybdenum.

According to the present invention, the term “sol-gel ceramic” is not subject to any particular restriction. In a preferred embodiment, the sol-gel ceramic is based on silicon oxide. During the sol-gel process, i.e. during application of the sol-gel ceramic coating to the raw mold, a silicon oxide skeleton is formed as support structure. The antiadhesion component, which is, for example, already present in the sol-gel process, is built into the voids of the skeleton. The use of a sol-gel ceramic as support structure in the coating according to the invention advantageously allows simple process integration without high environmental obligations as have to be satisfied, for example, in the case of an electrochemical coating.

In a further embodiment, the antiwear matrix comprises silicon carbide (SiC). The silicon carbide particles preferably have a particle size in the range from 0.1 μm to 5 μm, particularly preferably from 0.5 μm to 1.5 μm. In a preferred embodiment, the volume of the SiC particles in the coating is from 25 to 40% by volume, based on the total volume of the coating, particularly preferably from 30 to 35% by volume.

According to the present invention, the term “nanocrystalline hard materials” is not subject to any particular restriction as long as the hard materials have a particle size in the range below 10 μm, particularly preferably below 5 μm, since in the case of larger particles the adhesion contribution of the antiwear matrix is lower than in the case of smaller particles. The dispersion of small particles advantageously ensures, in the case of wear, that a sufficient proportion by volume of hard materials is always available at the surface of the coating. The hard materials on the surface of the coating cannot prevent abrasive wear, but can advantageously delay it significantly. The wear protection properties of the coating according to the invention is therefore better, the smaller the particle size of the hard materials and the higher the proportion by volume thereof. In one embodiment, the hard materials have a particle size of from 10 to 1000 nm, preferably from 20 to 500 nm. The hard materials can comprise, for example, tungsten carbide (WC), silicon carbide (SiC), molybdenum and/or nickel.

In a preferred embodiment, the antiadhesion component comprises a fluoropolymer, for example polytetrafluoro-ethylene (PTFE), tetrafluoroethylene-hexafluoropropylene copolymer (FEP), polychlorotrifluoroethylene (PCTFE), ethylene-tetrafluoroethylene (ETFE) or perfluoroalkoxy (PFA).

In a particularly preferred embodiment, the antiadhesion component comprises PTFE particles. The volume of the PTFE particles is not subject to any particular restriction according to the invention. In a preferred embodiment, the volume of the PTFE particles in the coating is from 15 to 35% by volume, based on the total volume of the coating, particularly preferably from 20 to 30% by volume. If the volume of the PTFE particles, based on the total volume of the coating, is too low, the coating according to the invention has an insufficient antiadhesion effect in respect of concrete. If the volume of the PTFE particles, based on the total volume of the coating, is too great, the stability of the support structure decreases, which leads to a reduction in the wear resistance of the mold of the invention.

The particle size of the PTFE particles is, according to the invention, not subject to any particular restriction.

In a preferred embodiment, the PTFE particles have a particle size of from 0.05 to 1.0 μm, particularly preferably from 0.1 to 0.5 μm. A homogeneous distribution of small-sized particles is particularly preferred over large-sized particles at the same volume concentration.

The thickness of the coating in the mold of the invention is not subject to any particular restriction. In a preferred embodiment, the coating has a thickness of from 5 to 500 μm, preferably from 10 to 50 μm. Layer thicknesses of greater than 500 μm lead to increasing internal stresses, which should be avoided.

In the production of a molded brick, it is often desirable to transfer a predefined fine structure from the molded brick mold to the finished (i.e. cured) molded brick, so that, firstly, this is given an esthetically pleasing, structured appearance and, secondly, no flat smooth molded brick which, in particular, can have excessively low adhesion when wet and thereby becomes slippery is obtained.

Such fine structures on the surface of molded brick molds (raised regions and depressions; see FIG. 4) are usually produced by complicated mechanical milling or eroding processes and the raised regions in particular are then subjected to extreme wear stresses during molded brick production, so that the appearance of the molded bricks produced changes over time. The coatings conventionally used as wear protection in the prior art also fill up in a disadvantageous way during application to the molded brick mold surface, primarily the depressions and at the same time the peaks and raised regions are rounded. In contrast, the use of the coating according to the invention advantageously makes it possible to achieve high wear protection while the overall appearance of the fine structuring on the molded brick mold remains unchanged and a contour-true coating is obtained. The excellent antiadhesion properties of the coating according to the invention also prevent the adhesion of concrete to these fine structures of the mold, which are particularly sensitive to adhesion of concrete, during molded brick production.

In addition, it has been found that the adhesion of concrete to extremely smooth mold surfaces is often greater than to molds having some surface structure. In the case of very smooth surfaces, it has been found, in particular, that above particular moisture values (i.e. high W/C values) of the concrete and when using particular aggregates, adhesion increases suddenly since the adhesive force between the water/cement mixture and the mold surface increases and a certain subatmospheric pressure arises between the mold and the molded brick surface, i.e. air cannot flow in quickly enough via the lateral periphery because of the extremely quick lifting of the pressure piece from the brick surface. The disadvantageous adhering material can then be a few millimeters in diameter, but can also have a size of some square centimeters.

Furthermore, it has been found that during the densification the pressure pieces move in a horizontally oscillating fashion relative to the concrete brick on the brick surface because of the machine induction of vibration. This produces very fine particles close to the surface in the concrete. It is precisely this additional, relative movement of the pressure pieces which scrapes the brick surface and gives it a better, closed surface. The amplitudes of these movements are only a few tenths of a millimeter (for example 0.1-0.5 mm) but this combination of horizontal movement and fine structure on the pressure piece surface intrinsically strengthens the concrete and at the same time leads to better detachment of the pressure piece from the brick surface without damaging the latter. The especial aspect is that this fine structure has to have the correct dimensions.

Accordingly, the surface of the mold of the invention has, in a preferred embodiment, a surface roughness Rz of from 1.6 to 25 μm, particularly preferably from 4 μm to 16 μm, at least in sections, in order to achieve the above-described advantageous technical effects. These values relate to the finished, i.e. the cured and coated, surface of the mold of the invention. It is therefore important that the roughness of the mold surface is not changed significantly on application of the coating according to the invention and also does not decrease prematurely as a result of wear during molded brick production. According to the invention, the surface roughness is determined in accordance with DIN 4760, DIN EN ISO 4287 and DIN EN ISO 4288 using the surface testing instrument “Tester T500” from Hommel.

The surface roughness mentioned is, in a particular embodiment, present on at least sections of the surface of the mold, for example on the surface of the pressure piece facing the molded brick or subregions thereof, on the surface of one or more mold nest interior walls or on the entire mold surface.

Furthermore, it has advantageously been found that color pigments optionally added to the concrete mixture can show up better, i.e. more intensively, as a result of the coating of the invention in combination with a particular fine structure of the surface.

In addition, there is advantageously no formation of elongated pits in the molded brick surface, as occurs when using molds known hitherto, when molded bricks are produced using the mold of the invention due to the specific coating and the fine structure which may optionally be present. Elongated pits usually have a length of a few millimeters up to a maximum of 2 or 3 cm, have a width and depth of from 2 to 3 mm and spoil the visual appearance of the molded bricks produced.

The present invention further provides a pressure piece for producing molded bricks, wherein at least the surface of the pressure piece which comes into contact with the molded brick composition during molded brick production has a coating, at least in sections, where the coating comprises an antiwear matrix and an antiadhesion component as defined above.

The geometric shape and size of the pressure piece are, according to the invention not subject to any particular restriction. The pressure piece of the invention can be configured freely depending on the molded brick to be produced and according to the molded brick mold used. In one embodiment, the surface of the pressure piece which comes into contact with the molded brick composition during molded brick production is completely covered by the coating according to the invention. In an alternative embodiment, only subregions of the surface are coated. Apart from coating of the surface of the pressure piece which comes into contact with the molded brick composition during molded brick production, it can also be advantageous to provide the outside (periphery) of the pressure piece which comes into contact with the mold nest wall with the coating according to the invention in order to provide this with wear protection. All that which has been said above concerning the coating comprising an antiwear matrix and an antiadhesion component of the mold of the invention also applies to the pressure piece of the invention. The present invention also provides pressure pieces which have a three-dimensionally structured surface which makes it possible to form a particular structure on the brick surface too. In this way, it is possible, for example, to replicate natural stone with a high-quality appearance.

In a further embodiment, the pressure piece has, at least in sections, a fine structure as defined above and in particular a surface roughness Rz of from 1.6 to 25 μm, particularly preferably from 4 μm to 16 μm.

The present invention further provides a process for producing the mold of the invention or the pressure piece of the invention, which comprises applying a coating as defined above to at least sections of a raw mold or a raw pressure piece.

For the purposes of the present invention, the terms “raw mold” and “raw pressure piece” refer to a mold or a pressure piece for producing molded bricks which consist of a suitable support material as described above and do not yet have any coating according to the invention or have a coating according to the invention which is already (partly) worn out.

The process of the invention is not subject to any particular restriction and the application can be carried out using coating methods known in the prior art.

In one embodiment, the nickel-phosphorus alloy is applied, optionally together with an additional antiadhesion component, to the surface of the raw mold or the raw pressure piece, for example by deposition from aqueous nickel salt solutions by reduction with hypophosphite. Such solutions are commercially available. The above process allows the surface shape of the components, i.e. mold and pressure piece, to be advantageously coated in a contour-true fashion. A person skilled in the art can control the phosphorus content of the coating, the layer thickness and further parameters by varying the solution composition and the process parameters.

In a preferred embodiment, a heat treatment which leads to recrystallization and formation of nickel phosphides on the surface is carried out after the deposition in the coating process of the invention. Advantageously, only a small thermal input is necessary here, so that no distortion or stresses arise(s) on/in the mold or the pressure piece.

In a further embodiment, the sol-gel ceramic is applied together with the antiadhesion component to the surface of the raw mold or the raw pressure piece by means of a sol-gel process. Starting materials for a sol-gel process are, for example, low molecular weight metallic alkoxide compounds, preferably based on silicon. These are hydrolyzed in the presence of acid or base to form a sol. Partial evaporation of the solvent then results in crosslinking of the particles to form a three-dimensional network which is still impregnated with the solvent (formation of a gel). Complete evaporation of the solvent results in formation of greater crosslinking of the network in the voids of which the antiadhesion component is incorporated. As an alternative, the antiadhesion component can also be introduced subsequently into the porous sol-gel ceramic.

In a further embodiment, the coating according to the invention can also be provided by known coating processes for fluoropolymer layers in the presence of silicon carbide and/or nanocrystalline hard materials. In an analogous way, the abovementioned compounds such as titanium nitrite, silicon nitride, tungsten carbides, DLC, zinc oxides, TiAlCN, AlCrN, AlTiCrN and/or ZrCrN can also serve as antiwear matrix in a corresponding fluoropolymer layer in order to form the antiwear matrix of the coating according to the invention there.

A person skilled in the art can set the physical properties of the coating in a targeted manner by subsequent heat treatment processes. Thus, for example, the strength of adhesion between component and coating and the hardness of the coating can be increased. In addition, it is possible to achieve a reduction of residual stresses, optimization of the sliding properties and an increase in the antiadhesive effect.

The process of the invention can advantageously also be used in the case of components which have previously been coated and whose coating has been removed by wear. The mold of the invention and the pressure piece of the invention can therefore be used a number of times as a result of reapplication of the coating, which was not possible in the case of components known hitherto since the wear layers known hitherto were diffusion layers. In addition, the process of the invention also enables only those subregions of the component which have experienced particularly high wear to be recoated, thus saving money.

The present invention further provides an apparatus for producing molded bricks, comprising
a vibratable base with or without metal drawing sheet;
the mold of the invention for producing molded bricks, where the mold is placed with the mold underside downward on the vibratable base and can be filled from above with a molded brick composition; and
one or more pressure pieces according to the invention which can at least partly close the upper side of the mold.

A vibratable base (production base) in a plant for producing molded bricks is known in the prior art. Vibratable bases usually consist of wood, plastic or steel. After production, the bricks produced usually remain on these bases and are only lifted off a day later. Metal drawing sheets can be provided between the lower edge of the mold and the production bases and these then usually also have profiling facing the underside of the brick so that the brick is given corresponding counterprofiling on its underside. Such metal drawing sheets are known in the prior art.

The present invention further provides a vibratable base for producing molded bricks, wherein at least the surface of the vibratable base which is in contact with the mold and/or the molded brick composition during the molded brick production has, at least in sections, a coating, where the coating comprises an antiwear matrix and an antiadhesion component as defined above.

The present invention further provides a metal drawing sheet for producing molded bricks, wherein at least the surface of the metal drawing sheet which comes into contact with the mold and/or the molded brick composition during molded brick production has, at least in sections, a coating, where the coating comprises an antiwear matrix and an antiadhesion component as defined above.

According to the present invention, the metal drawing sheet can also have, at least in sections, a fine structure as defined above, in particular a surface roughness Rz of from 1.6 to 25 μm, particularly preferably from 4 μm to 16 μm.

The present invention further provides for the use of coatings comprising an antiwear matrix and an antiadhesion component for surfaces of molds and/or pressure pieces and/or vibratable bases and/or metal drawing sheets which are used for producing molded bricks. What has been said above with regard to the coating of the mold of the invention also applies to the use according to the invention.

The above-defined coating of the mold of the invention or of the pressure piece of the invention or of the apparatus of the invention, which makes it possible to provide molded bricks having excellent brick strength, advantageously leads to increased wear protection of these components and to improved antiadhesion in respect of molded brick compositions. Owing to the increased wear resistance of the components of the invention, the maximum use time thereof increases by from 20 to 50% compared to conventional components. In addition, the coating according to the invention is inert under the usual production conditions for molded bricks, so that no reaction of materials released by abrasion with the molded brick occurs and thus there is no undesirable discoloration of the molded brick surface. The components according to the invention therefore allow any discoloration on the molded bricks to be reduced by from 70 to 80% (see FIG. 3).

Owing to the excellent antiadhesion properties, the components of the invention are easy and thus quick to claim, as a result of which the production interruption times can advantageously be reduced significantly and the risk of molded brick material present in the stock hopper drying out can thus be reduced. In addition, it is advantageously no longer necessary to heat the pressure pieces in order to avoid adhesion of concrete, so that the abovementioned disadvantages of a heating device can be overcome and the molded bricks can be produced significantly more cheaply. The coating according to the invention gives components having excellent wear resistance and release properties since in the case gradual wear of the antiadhesion component, the support structure (antiwear matrix) wears at the same time and further particles of the antiadhesion component are thus exposed. In addition, the components according to the invention can be used a number of times in an uncomplicated manner by renewed application of the coating, which was hitherto not possible in the prior art and therefore leads to significant cost savings, especially as a result of the possibility of partial recoating of particularly stressed regions. The mold of the invention additionally allows production of molded bricks which have no or only little discoloration (see FIG. 3, right-hand image).

Furthermore, the coating according to the invention advantageously enables high wear protection to be provided while the overall appearance of any fine structuring applied to the molded brick mold and/or the pressure pieces remains substantially unchanged and contour-true coating is obtained. The excellent antiadhesion properties of the coating according to the invention also prevent adhesion of concrete to these fine structures of the mold, which are particularly sensitive to adhesion of concrete, during molded brick production. Furthermore, color pigments optionally added to the concrete mixture show up better, i.e. more intensively, as a result of the coating of the invention and disadvantageous elongated pits in the molded brick surface can be avoided.

In addition, the coating process of the invention offers the advantage that the physical properties of the components can be set in a targeted manner and thus only little heating of the components is necessary, so that no distortion and stresses arise on/in the components during production of the components.

The figures show:

FIG. 1 shows a mold upper part (1) at the lower end of which pressure pieces (3) having a pressure piece side face (4) and a pressure piece surface (5) are located, and also a mold lower part (2) having a mold lower part upper side (6), a mold lower part underside (7) and having a plurality of mold nests (8).

FIG. 2 shows defects on the brick upper side (9) of molded bricks which have been produced without the coating according to the invention on mold and pressure piece.

FIG. 3 shows molded bricks which have been produced without (at left) and with (at right) coating according to the invention of the respective components (brick upper side (9), brick side face (10)).

FIG. 4 shows a mold surface with fine structuring.

### LIST OF REFERENCE NUMERALS

1 Mold upper part
2 Mold lower part
3 Pressure pieces
4 Pressure piece side face
5 Pressure piece surface
6 Mold lower part upper side
7 Mold lower part underside
8 Mold nests
9 Brick upper side
10 Brick side face

1. A mold for producing molded bricks, wherein
the mold has one or more mold nests which can be filled with molded brick composition and have an open upper side and an open underside;
the mold nests have mold nest walls between the upper side and the underside; and
the mold nest walls have a coating at least in sections on the surfaces which come into contact with a pressure piece and/or with the molded brick composition during filling, where the coating comprises an antiwear matrix and an antiadhesion component and
the antiwear matrix is selected from among nickel-phosphorus alloy, sol-gel ceramic, silicon carbide (SiC), nanocrystalline hard materials, titanium nitrite, silicon nitride, tungsten carbides, DLC, zinc oxides, TiAlCN, AlCrN, AlTiCrN and/or ZrCrN.

2. The mold as claimed in claim 1, wherein the antiwear matrix is selected from among nickel-phosphorus alloy, sol-gel ceramic, silicon carbide and nanocrystalline hard materials.

3. The mold as claimed in claim 2, wherein the nickel-phosphorus alloy has a phosphorus content of from 3 to 14% by weight, based on the total weight of the coating.

4. The mold as claimed in any of claims 1 to 3, wherein the antiadhesion component comprises a fluoropolymer.

5. The mold as claimed in any of claims 1 to 4, wherein the antiadhesion component comprises PTFE particles.

6. The mold as claimed in claim 5, wherein the volume of the PTFE particles in the coating is from 15 to 35% by volume, based on the total volume of the coating.

7. The mold as claimed in claim 5 or 6, wherein the PTFE particles have a particle size of from 0.05 to 1.00 μm.

8. The mold as claimed in any of claims 1 to 7, wherein the coating has a thickness of from 5 to 500 μm.

9. The mold as claimed in any of claims 1 to 8, wherein the surface of the mold has, at least in sections, a surface roughness Rz of from 1.6 to 25 μm.

10. A pressure piece for producing molded bricks, wherein at least the surface of the pressure piece which comes into contact with the molded brick composition during molded brick production has a coating, at least in sections, as defined in any of claims 1 to 9.

11. A process for producing a mold as claimed in any of claims 1 to 9 or a pressure piece as claimed in claim 10, which comprises applying a coating as defined in any of claims 1 to 9 to at least sections of a raw mold or a raw pressure piece.

12. The process as claimed in claim 11, further comprising heat treatment of the coated mold or of the coated pressure piece after the coating operation.

13. An apparatus for producing molded bricks, comprising
a vibratable base;
a mold as claimed in any of claims 1 to 9, where the mold is placed with the mold underside downward on the vibratable base and can be filled from above with a molded brick composition; and
one or more pressure pieces as claimed in claim 10 which can at least partly close the upper side of the mold.

14. A vibratable base for producing molded bricks, wherein at least the surface of the vibratable base which is in contact with the mold and/or the molded brick composition and/or a metal drawing sheet during the molded brick production has, at least in sections, a coating as defined in any of claims 1 to 9.

15. A metal drawing sheet for producing molded bricks, wherein at least the surface of the metal drawing sheet which comes into contact with the mold and/or the molded brick composition during molded brick production has, at least in sections, a coating as defined in any of claims 1 to 9.

16. The use of a coating for surfaces of molds and/or pressure pieces and/or vibratable surfaces and/or metal drawing sheets which are used for producing molded bricks, wherein the coating is as defined in any of claims 1 to 9.
